(19) United States
(12) Patent Application Publication
(10) Pub. No.: US 2018/0133740 A1
(43) Pub. Date: May 17, 2018

(54) Baseboard and Floor Protecting Paint Template System

(71) Applicant: Hugo Martinez, Charlotte, NC (US)

(72) Inventor: Hugo Martinez, Charlotte, NC (US)

(21) Appl. No.: 15/352,189

(22) Filed: Nov. 15, 2016

(51) Int. Cl. B05B 15/04; B05C 21/00

(52) U.S. Cl. CPC B05B 15/0475; B05C 21/005

(57) ABSTRACT

A paint template system includes a vertical support surface and a horizontal support surface intersecting the vertical support surface. A baseboard is coupled to the vertical support surface. The baseboard is coextensive with an intersection between the vertical support surface and the horizontal support surface. A template is provided and the template is selectively positioned on the horizontal support surface. Thus, the template inhibits paint from spilling on the horizontal support surface when the vertical support surface is painted. The template is selectively positioned to cover the baseboard. Thus, the template inhibits the paint from contacting the baseboard when the vertical support surface is painted.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to template devices and more particularly pertains to a new template device for protecting a floor and a baseboard from paint when a wall is painted.

### BRIEF SUMMARY OF THE INVENTION

An embodiment of the disclosure meets the needs presented above by generally comprising a vertical support surface and a horizontal support surface intersecting the vertical support surface. A baseboard is coupled to the vertical support surface. The baseboard is coextensive with an intersection between the vertical support surface and the horizontal support surface. A template is provided and the template is selectively positioned on the horizontal support surface. Thus, the template inhibits paint from spilling on the horizontal support surface when the vertical support surface is painted. The template is selectively positioned to cover the baseboard. Thus, the template inhibits the paint from contacting the baseboard when the vertical support surface is painted.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a panel of a paint template system according to an embodiment of the disclosure.

FIG. 2 is a bottom view of a panel of an embodiment of the disclosure.

FIG. 3 is a left side view of a panel of an embodiment of the disclosure.

FIG. 4 is a front view of a panel of an embodiment of the disclosure.

FIG. 5 is a perspective in-use view of an embodiment of the disclosure.

### DETAILED DESCRIPTION OF THE INVENTION

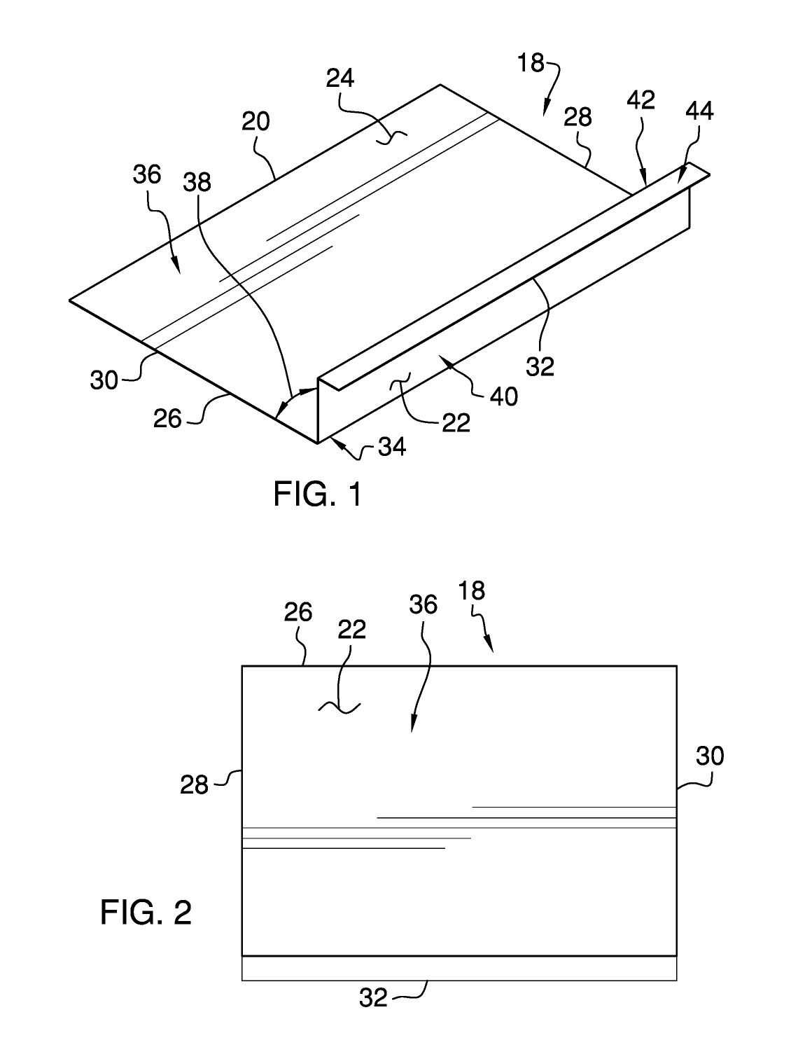

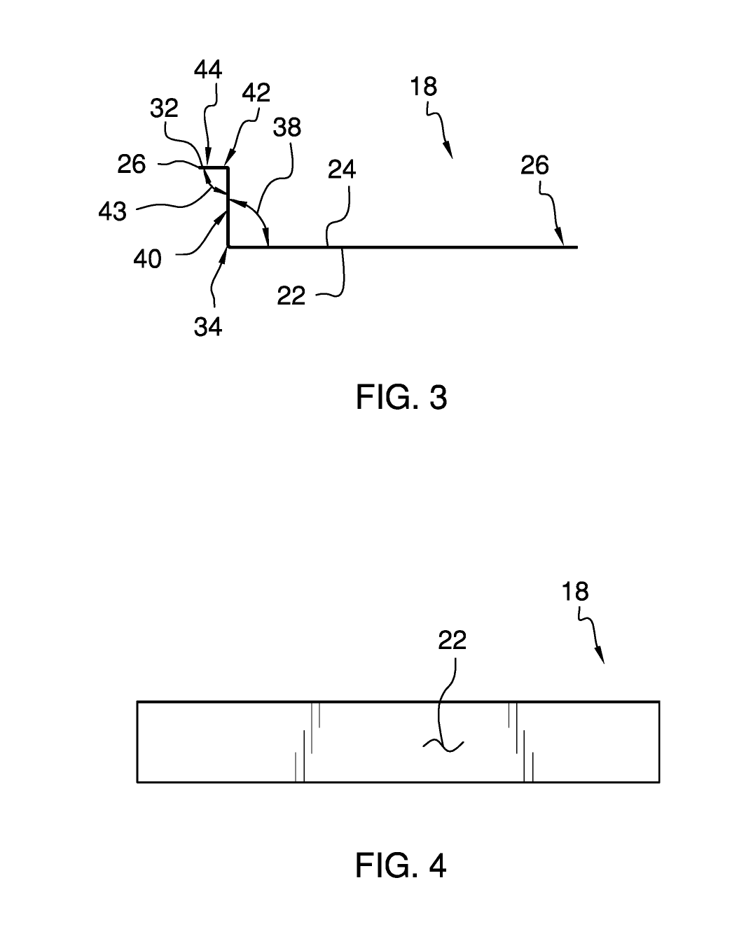

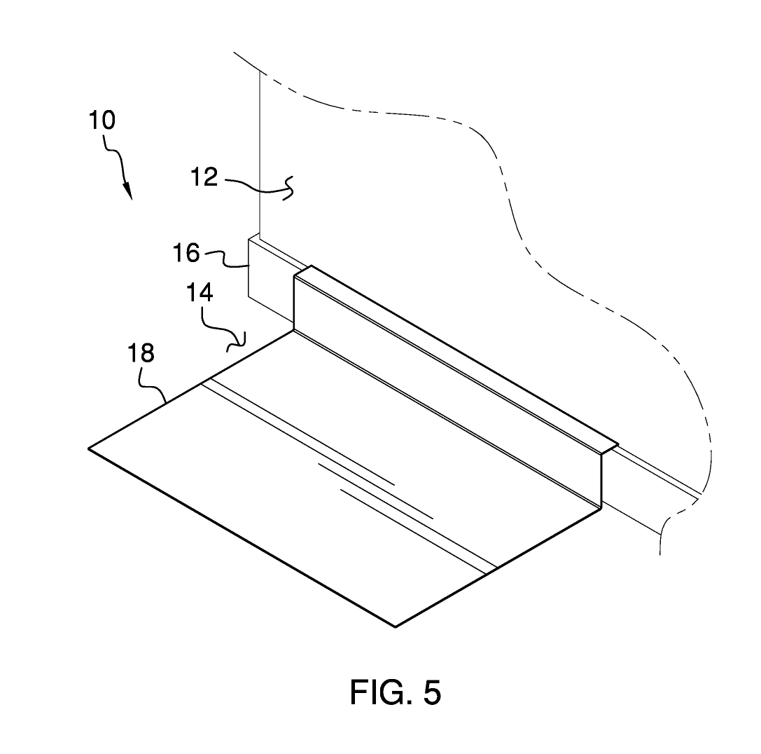

With reference now to the drawings, and in particular to FIGS. 1 through 5 thereof, a new template device embodying the principles and concepts of an embodiment of the disclosure and generally designated by the reference numeral 10 will be described.

As best illustrated in FIGS. 1 through 5, the paint template system 10 generally comprises a vertical support surface 12. The vertical support surface 12 may be an interior wall in a building or the like. A horizontal support surface 14 is included and the horizontal support surface 14 intersects the vertical support surface 12. The horizontal support surface 14 may be a floor in the building or the like.

A baseboard 16 is provided. The baseboard 16 is coupled to the vertical support surface 12. Moreover, the baseboard 16 is coextensive with an intersection between the vertical support surface 12 and the horizontal support surface 14. The baseboard 16 may be baseboard 16 of any conventional design.

A template 18 is provided and the template 18 is selectively positioned on the horizontal support surface 14. Thus, the template 18 inhibits paint from spilling on the horizontal support surface 14 when the vertical support surface 12 is painted. The paint may be latex paint applied with a roller or the like. The template 18 is selectively positioned to cover the baseboard 16. Thus, the template 18 inhibits the paint from contacting the baseboard 16 when the vertical support surface 12 is painted.

The template 18 comprises a plate 20 that has a first surface 22, a second surface 24 and a peripheral edge 26 extending therebetween. The peripheral edge 26 has a first lateral side 28, a second lateral side 30 and a front side 32. The plate 20 has a first bend 34 thereon to define a first horizontal portion 36 forming a first angle 38 with a vertical portion 40. Moreover, the first bend 34 extends between the first lateral side 28 and the second lateral side 30.

The plate 20 has a second bend 42 thereon to define a second horizontal portion 44 forming a second angle 43 with the vertical portion 40. The second bend 42 extends between the first lateral side 28 and the second lateral side 30. The first angle 38 is congruent with the second angle 43. Thus, the second horizontal portion 44 is oriented parallel with the first horizontal portion 36. The first bend 34 is spaced from the second bend 42.

The plate 20 may have a width ranging between eighty five cm and ninety five cm. The first horizontal portion 36 may have a length ranging between thirty five cm and forty five cm. The vertical portion 40 may have a height ranging between seven cm and fifteen cm. Finally, the second horizontal portion 44 may have a length ranging between two cm and ten cm.

In use, that plate 20 is positioned on the horizontal support surface 14 when vertical support surface 12 is to be painted. The first surface 22 corresponding to the first horizontal portion 36 rests on the horizontal support surface 14. Thus, the second surface 24 corresponding to the first horizontal portion 36 inhibits the paint from contacting the horizontal support surface 14. The front side 32 abuts the vertical support surface 12 having the second horizontal portion 44 being spaced from the baseboard 16. Thus, the second surface 24 corresponding to the second horizontal portion 44 inhibits the paint from contacting the base board. The plate 20 is selectively moved along an entire length of the vertical support surface 12 when the vertical support surface 12 is painted.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A paint template system comprising:
a vertical support surface;
a horizontal support surface intersecting said vertical support surface;
a baseboard being coupled to said vertical support surface, said baseboard being coextensive with an intersection between said vertical support surface and said horizontal support surface; and
a template being selectively positioned on said horizontal support surface wherein said template is configured to inhibit paint from spilling on said horizontal support surface when said vertical support surface is painted, said template being selectively positioned to cover said baseboard wherein said template is configured to inhibit the paint from contacting said baseboard when said vertical support surface is painted, said template comprising a plate having a first surface, a second surface and a peripheral edge extending therebetween, said peripheral edge having a first lateral side, a second lateral side and a front side, said plate having a first bend thereon to define a first horizontal portion forming a first angle with a vertical portion, said first bend extending between said first lateral side and said second lateral side, said plate having a second bend thereon to define a second horizontal portion forming a second angle with a vertical portion, said second bend extending between said first lateral side and said second lateral side, said vertical portion being planar and continuous extending between said first bend and said second bend.

2. (canceled)

3. (canceled)

4. (canceled)

5. The system according to claim 1, wherein
said first angle is congruent with said second angle such that said second horizontal portion is oriented parallel with said first horizontal portion, said first bend being spaced from said second bend.

6. The system according to claim 5, wherein said plate is selectively positioned having said first surface corresponding to said first horizontal portion resting on said horizontal support surface wherein said second surface corresponding to said first horizontal portion is configured to inhibit the paint from contacting said horizontal support surface.

7. The system according to claim 5, wherein said panel is selectively positioned having said front side abutting said vertical support surface having said second horizontal portion being spaced from said baseboard wherein said second surface corresponding to said second horizontal portion is configured to inhibit the paint from contacting said baseboard.

8. A paint template system comprising:
a vertical support surface;
a horizontal support surface intersecting said vertical support surface;
a baseboard being coupled to said vertical support surface, said baseboard being coextensive with an intersection between said vertical support surface and said horizontal support surface; and
a template being selectively positioned on said horizontal support surface wherein said template is configured to inhibit paint from spilling on said horizontal support surface when said vertical support surface is painted, said template being selectively positioned to cover said baseboard wherein said template is configured to inhibit the paint from contacting said baseboard when said vertical support surface is painted, said template comprising a plate having a first surface, a second surface and a peripheral edge extending therebetween, said peripheral edge having a first lateral side, a second lateral side and a front side, said plate having a first bend thereon to define a first horizontal portion forming a first angle with a vertical portion, said first bend extending between said first lateral side and said second lateral side, said plate having a second bend thereon to define a second horizontal portion forming a second angle with said vertical portion, said second bend extending between said first lateral side and said second lateral side, said first angle being congruent with said second angle such that said second horizontal portion is oriented parallel with said first horizontal portion, said first bend being spaced from said second bend, said vertical portion being planar and continuous extending between said first bend and said second bend, said first surface corresponding to said first horizontal portion resting on said horizontal support surface wherein said second surface corresponding to said first horizontal portion is configured to inhibit the paint from contacting said horizontal support surface, said front side abutting said vertical support surface having said second horizontal portion being spaced from said baseboard wherein said second surface corresponding to said second horizontal portion is configured to inhibit the paint from contacting said baseboard.
